(19) United States
(12) Patent Application Publication
(10) Pub. No.: US 2026/0115991 A1
(43) Pub. Date: Apr. 30, 2026

(54) HOUSING MANUFACTURING METHOD

(71) Applicant: ASUSTEK COMPUTER INC., TAIPEI (TW)

(72) Inventors: Jun-Hui ZOU, TAIPEI (TW); Po-Wen HUANG, TAIPEI (TW); Yu-Chun YANG, TAIPEI (TW); Gou-Lin YANG, TAIPEI (TW); Er-Bao NIU, TAIPEI (TW)

(21) Appl. No.: 19/076,357

(22) Filed: Mar. 11, 2025

(30) Foreign Application Priority Data
Oct. 29, 2024 (CN) 202411525020.0

(51) Int. Cl. B29C 48/79; B29C 48/00; B29K 201/00; B29L 7/00; B29L 31/34

(52) U.S. Cl. CPC B29C 48/79; B29C 48/001; B29C 48/022; B29K 2201/00; B29L 2007/002; B29L 2031/3481

(57) ABSTRACT

A housing manufacturing method is provided. The housing manufacturing method includes the following steps. First, a plant carbon fiber plate is provided. Subsequently, a stamping process is applied to the plant carbon fiber plate to form a carbon fiber housing. Then a decorative surface is formed on the carbon fiber housing through an in-mold injection molding process. Steps of manufacturing the plant carbon fiber plate are as follows. First, a plant raw material is provided. Subsequently, a first low-temperature carbonization process is applied to the plant raw material to form a carbonized plant raw material. Then a resin material is added to form a carbonized plant mixed material. Next, a second low-temperature carbonization process is applied to the carbonized plant mixed material to generate a plant carbon fiber raw material. Then the plant carbon fiber raw material is extruded, spun, and shaped to form a plant carbon fiber plate.

### CROSS-REFERENCE TO RELATED APPLICATION

This application claims the priority benefit of Chinese Application Serial No. 202411525020.0, filed on Oct. 29, 2024. The entirety of the above-mentioned patent application is hereby incorporated by reference herein and made a part of specification.

### BACKGROUND OF THE INVENTION

### Field of the Invention

The disclosure relates to a housing manufacturing method, and in particular, to a housing manufacturing method using a plant carbon fiber plate.

### Description of the Related Art

A carbon fiber plate includes advantages such as light weight, high strength, high rigidity, and corrosion resistance, and is used as a housing material of an electronic device.

However, limited by material properties of carbon fiber, it is not easy to process a precise surface design for a conventional carbon fiber housing. Therefore, the conventional carbon fiber housing has poor surface accuracy, and a housing appearance and a subsequent surface treatment technology are greatly limited.

In addition to this, a manufacturing process of a conventional carbon fiber plate requires a high-temperature and high-pressure environment, resulting in high manufacturing costs and affecting product competitiveness.

### BRIEF SUMMARY OF THE INVENTION

The disclosure provides a housing manufacturing method. The housing manufacturing method includes the following steps. First, a plant carbon fiber plate is provided. Subsequently, a stamping process is applied to the plant carbon fiber plate to form a carbon fiber housing. Then a decorative surface is formed on the carbon fiber housing through an in-mold injection molding process. Steps of manufacturing the plant carbon fiber plate are as follows. First, a plant raw material is provided. Subsequently, a first low-temperature carbonization process is applied to the plant raw material to form a carbonized plant raw material. Then a resin material is added to the carbonized plant raw material to form a carbonized plant mixed material. Next, a second low-temperature carbonization process is applied to the carbonized plant mixed material to generate a plant carbon fiber raw material. Then the plant carbon fiber raw material is extruded and spun to generate a plant carbon fiber material. Finally, the plant carbon fiber plate is formed through the plant carbon fiber material.

A plant carbon fiber housing provided in the disclosure has the following advantages. First, compared with a conventional carbon fiber plate, the plant carbon fiber plate of the disclosure is more environment-friendly, and the manufacturing process does not need a high-temperature and high-pressure environment and requires lower costs. Secondly, strength and toughness of the plant carbon fiber plate provided in the disclosure are obviously superior to those of the conventional carbon fiber material.

### BRIEF DESCRIPTION OF THE DRAWINGS

FIG. 1 is a flowchart of a housing manufacturing method according to an embodiment of the disclosure;

FIG. 2 shows an embodiment of step S120 in FIG. 1;

FIG. 3 shows an embodiment of step S140 in FIG. 1;

FIG. 4 is a flowchart of a housing manufacturing method according to another embodiment of the disclosure; and

FIG. 5 shows an embodiment of step S480 in FIG. 4.

### DETAILED DESCRIPTION OF THE EMBODIMENTS

Specific embodiments of the disclosure are described in more details below with reference to the schematic diagrams. Advantages and features of the disclosure are to be clearer based on the following descriptions and claims. It is to be noted that all of the accompanying drawings are in a very simple form and in an inaccurate proportion, and are merely intended to assist in illustrating the embodiments of the disclosure conveniently and clearly.

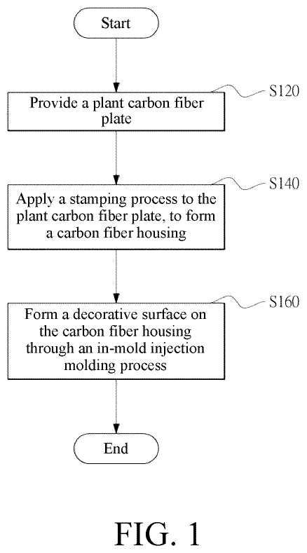

FIG. 1 is a flowchart of a housing manufacturing method according to an embodiment of the disclosure.

As shown in the figure, the housing manufacturing method provided in this embodiment includes the following steps.

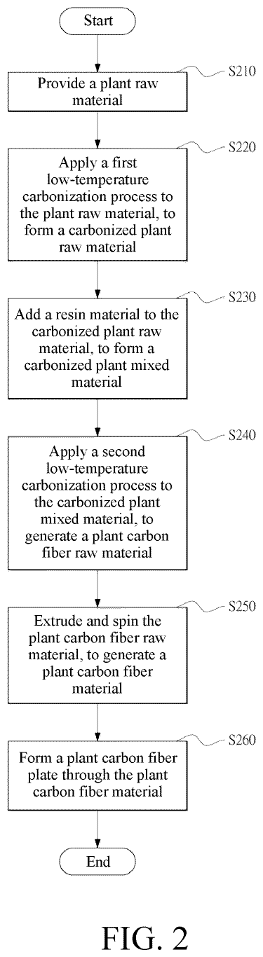

First, as described in step S120, a plant carbon fiber plate is provided. A manufacturing process of the plant carbon fiber plate is to be described in more detail in a subsequent embodiment described in FIG. 2. In short, the plant carbon fiber plate is manufactured through a plant raw material through a low-temperature carbonization and shaping process.

Subsequently, as described in step S140, a stamping process is applied to the plant carbon fiber plate to form a carbon fiber housing.

Then as described in step S160, a decorative surface is formed on the carbon fiber housing through an in-mold injection molding process. In an embodiment, the in-mold injection molding process is an in-mold decoration (IMD) process. However, the disclosure is not limited thereto. In another embodiment, the in-mold injection molding process is also to place a carbon fiber housing in a mold cavity, and then form a flat surface on the carbon fiber housing as a decorative surface through injection molding.

Referring to FIG. 2 together, FIG. 2 is an embodiment of step S120 in FIG. 1.

First, as described in step S210, a plant raw material is provided. In an embodiment, the plant raw material is wood or straw.

Then as described in step S220, a first low-temperature carbonization process is applied to the plant raw material to form a carbonized plant raw material. In an embodiment, a carbonization temperature of the first low-temperature carbonization process is in a range of 120-180 degrees Celsius, and a carbonization time is greater than 60 minutes. Moreover, in an embodiment, to stabilize the carbonized plant raw material, after the first low-temperature carbonization process, the carbonized plant raw material is sealed and left in a container for at least 120 hours to complete preparation for subsequent process steps.

Subsequently, as described in step S230, a resin material is added to the carbonized plant raw material to form a carbonized plant mixed material. In an embodiment, the resin material is epoxy resin.

Next, as described in step S240, a second low-temperature carbonization process is applied to the carbonized plant mixed material to generate a plant carbon fiber raw material. In an embodiment, a carbonization temperature of the second low-temperature carbonization process is in a range of 120-180 degrees Celsius, and a carbonization time is greater than 60 minutes.

Moreover, in an embodiment, to stabilize the plant carbon fiber raw material, after the second low-temperature carbonization process, the plant carbon fiber raw material is sealed and left in a container for at least 150 hours to complete preparation for subsequent process steps.

Subsequently, as described in step S250, the plant carbon fiber raw material is extruded and spun to generate a plant carbon fiber material.

Finally, as described in step S260, the plant carbon fiber plate is formed through the plant carbon fiber material. In an embodiment, in this step, the plant carbon fiber material is first formed into a carbon fiber prepreg cloth, and then the carbon fiber prepreg cloth is stacked and hot-pressed to form a plant carbon fiber plate.

In the foregoing step S260, weaving and shaping are performed or a rolling operation is directly performed based on an actual design requirement (such as a surface texture and a thickness of the plant carbon fiber plate).

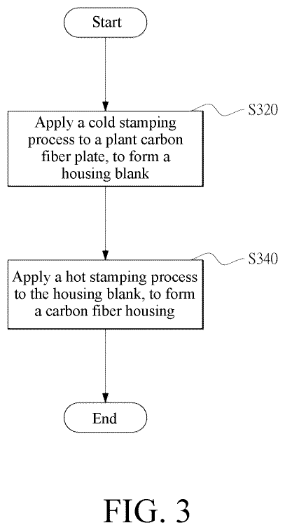

Referring to FIG. 3 together, FIG. 3 is an embodiment of step S140 in FIG. 1.

First, as described in step S320, a cold stamping process is applied to the plant carbon fiber plate to form a housing blank. The purpose of the cold stamping process is to form a basic shape of a housing.

Then as described in step S340, a hot stamping process is applied to the housing blank to form a carbon fiber housing. The purpose of the cold stamping process is to form a detailed structure of the housing on the basic shape of the housing.

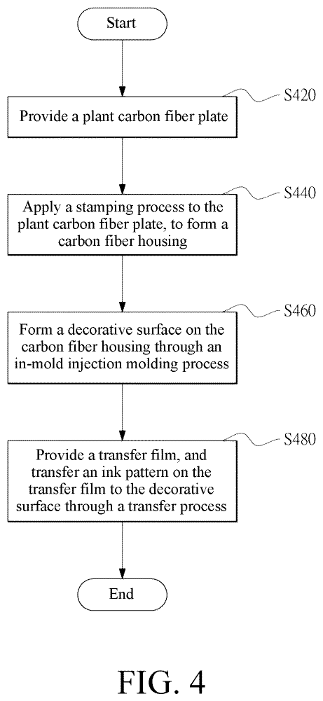

Referring to FIG. 4 together, FIG. 4 is a flowchart of a housing manufacturing method according to another embodiment of the disclosure.

As shown in the figure, the housing manufacturing method provided in this embodiment includes the following steps.

First, as described in step S420, a plant carbon fiber plate is provided.

Subsequently, as described in step S440, a stamping process is applied to the plant carbon fiber plate to form a carbon fiber housing.

Then as described in step S460, a decorative surface is formed on the carbon fiber housing through an in-mold injection molding process.

Next, as described in step S480, a transfer film is provided, and an ink pattern on the transfer film is transferred to the decorative surface through a transfer process.

The foregoing steps S420, S440, and S460 are similar to steps S120, S140, and S160 in FIG. 1. Details are not described herein.

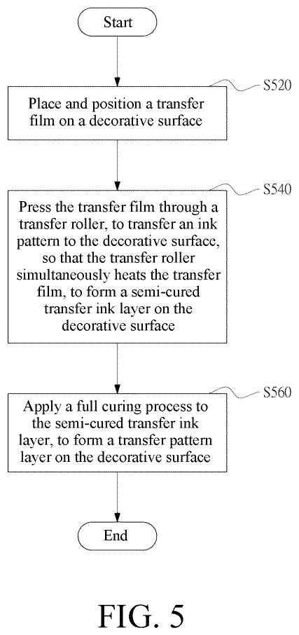

Referring to FIG. 5 together, FIG. 5 shows an embodiment of step S480 in FIG. 4.

First, as described in step S520, the transfer film is placed and positioned on the decorative surface.

Then as described in step S540, a transfer roller is used to press the transfer film to transfer the ink pattern to the decorative surface, and the transfer roller simultaneously heats the transfer film to form a semi-cured transfer ink layer on the decorative surface.

Then as described in step S560, a full curing process is applied to the semi-cured transfer ink layer to form a transfer pattern layer on the decorative surface. In an embodiment, the full curing process is a photocuring process.

A plant carbon fiber housing provided in the disclosure has the following advantages. First, compared with a conventional carbon fiber plate, the plant carbon fiber plate of the disclosure is more environment-friendly, and the manufacturing process does not need a high-temperature and high-pressure environment and requires lower costs. Secondly, strength and toughness of the plant carbon fiber plate provided in the disclosure are obviously superior to those of the conventional carbon fiber material.

Next, according to the housing manufacturing method of the disclosure, the in-mold injection molding process is used with a plant carbon fiber housing, so that a flat decorative surface is formed on the plant carbon fiber housing, which helps alleviate a problem of poor surface accuracy of the conventional carbon fiber housing, and helps decorate the plant carbon fiber housing with a subsequent housing appearance and a surface treatment process (such as a transfer process).

Although the disclosure has been disclosed above through the embodiments, the embodiments are not intended to limit the disclosure. Any person skilled in the art makes some changes and modifications without departing from the idea and scope of the disclosure. Therefore, the protection scope of the disclosure is defined by the claims.

What is claimed is:

1. A housing manufacturing method, comprising:
providing a plant carbon fiber plate;
applying a stamping process to the plant carbon fiber plate to form a carbon fiber housing; and
forming a decorative surface on the carbon fiber housing through an in-mold injection molding process,
wherein the manufacturing steps of the plant carbon fiber plate comprise:
providing a plant raw material;
applying a first low-temperature carbonization process to the plant raw material to form a carbonized plant raw material;
adding a resin material to the carbonized plant raw material to form a carbonized plant mixed material;
applying a second low-temperature carbonization process to the carbonized plant mixed material, to generate a plant carbon fiber raw material;
extruding and spinning the plant carbon fiber raw material, to generate a plant carbon fiber material; and
forming the plant carbon fiber plate through the plant carbon fiber material.

2. The housing manufacturing method according to claim 1, wherein the step of applying the stamping process to the plant carbon fiber plate to form the carbon fiber housing comprises:
applying a cold stamping process to the plant carbon fiber plate to form a housing blank; and
applying a hot stamping process to the housing blank to form the carbon fiber housing.

3. The housing manufacturing method according to claim 1, wherein a carbonization temperature of the first low-temperature carbonization process is in a range of 120-180 degrees Celsius, and a carbonization time is greater than 60 minutes.

4. The housing manufacturing method according to claim 1, wherein a carbonization temperature of the second low-temperature carbonization process is in a range of 120-180 degrees Celsius, and a carbonization time is greater than 60 minutes.

5. The housing manufacturing method according to claim 1, wherein after applying the first low-temperature carbonization process to the plant raw material to form the carbonized plant raw material, the method further comprises:
sealing and leaving the carbonized plant raw material for at least 120 hours.

6. The housing manufacturing method according to claim 1, wherein after applying the second low-temperature carbonization process to the carbonized plant mixed material, to generate the plant carbon fiber raw material, the method further comprises:
sealing and leaving the plant carbon fiber raw material for at least 150 hours.

7. The housing manufacturing method according to claim 1, further comprising: providing a transfer film, and transferring an ink pattern on the transfer film to the decorative surface through a transfer process.

8. The housing manufacturing method according to claim 7, wherein the step of providing the transfer film, and transferring the ink pattern on the transfer film to the decorative surface through the transfer process comprises:
placing and positioning the transfer film on the decorative surface; and
pressing the transfer film through a transfer roller, to transfer the ink pattern to the decorative surface.

9. The housing manufacturing method according to claim 8, wherein the transfer roller simultaneously heats the transfer film while pressing the transfer film, to form a semi-cured transfer ink layer on the decorative surface.

10. The housing manufacturing method according to claim 9, further comprising: applying a full curing process to the semi-cured transfer ink layer to form a transfer pattern layer on the decorative surface.
